(19) United States
(12) Patent Application Publication
(10) Pub. No.: US 2009/0038820 A1
(43) Pub. Date: Feb. 12, 2009

(54) COATING NEURAL ELECTRODES WITH CARBON NANOTUBES AND VARIATIONS

(76) Inventor: Edward W. Keefer, Dallas, TX (US)

Correspondence Address: CARR LLP, 670 FOUNDERS SQUARE, 900 JACKSON STREET, DALLAS, TX, 75202, US

(21) Appl. No.: 12/188,897

(22) Filed: Aug. 8, 2008

Related U.S. Application Data
(60) Provisional application No. 60/955,259, filed on Aug. 10, 2007.
(60) Provisional application No. 60/973,150, filed on Sep. 17, 2007.

(51) Int. Cl. H01B 7/00; C08F 2/46

(52) U.S. Cl. 174/119 C; 427/487; 257/E21.576; 977/932

(57) ABSTRACT

The present invention provides a method and system of using carbon nanotubes (CNTs) to coat neural electrodes of different geometries and materials. Additional elements such as gold platinum, polypyrrole, polyethylenedioxythiophene or other conductive polymers and covalent linkage through an amide bond are formed with the CNTs for attachment to the neural electrodes. Such CNT-coated electrodes have properties that improve the recording or stimulation characteristics of the electrodes, thus aiding the study of neural functions or the treatment of neural diseases.

### CROSS-REFERENCE TO RELATED APPLICATIONS

This application relates to, and claims the benefit of the filing date of, co-pending U.S. provisional patent application Ser. No. 60/955,259 entitled IMPROVED NEUROELECTRODE CHARACTERISTICS USING NANOMATERIALS, filed Aug. 10, 2007, and co-pending U.S. provisional patent application Ser. No. 60/973,150 entitled COATING NEURAL ELECTRODES WITH CNT/CONDUCTIVE POLYMER COMPOSITES, filed Sep. 17, 2007, the entire contents of which are both incorporated herein by reference for all purposes.

### TECHNICAL FIELD

The present invention relates generally to the field of instrumentation for neural systems and, more particularly, to methods and systems for coating metal electrodes such as used for a study or a treatment of neural medical conditions.

### BACKGROUND

Electrical devices have been implanted in the nervous system to study neural functions or treat neural diseases that may result from faulty electrical signals in the brain. Electrical stimulation of the nervous system is used to ameliorate conditions such as tetraplegia, epilepsy, Parkinson disease, depression, hearing loss and chronic pain. The recent demonstration of willful computer cursor movement by a tetraplegic patients and remarkable work showing animal neural control of external devices offer hope that currently-intractable clinical conditions can be treated. While the efficacy of any of these interventions is generally determined by the quality of the neuron-electrode interface or brain-machine interface, however, creating a universal interface with selectivity, sensitivity, good charge transfer characteristics and long-term chemical and recording stability remains a formidable challenge.

### SUMMARY

The present invention provides a method and system of attaching carbon nanotubes (CNTs) to neural electrodes of different geometries and materials. Additional elements such as gold, platinum, polypyrrole, polyethylenedioxythiophene or other conductive polymers and covalent linkage through an amide bond are formed with the CNTs for attachment to the neural electrodes. Such CNT-coated electrodes have properties that improve the recording or stimulation characteristics of the electrodes, thus aiding the study of neural functions or the treatment of neural diseases.

### BRIEF DESCRIPTION OF THE DRAWINGS

For a more complete understanding of the present invention and the advantages thereof, reference is now made to the following descriptions taken in conjunction with the accompanying drawings, in which:

FIGS. 1a-f depicts characterization of CNT-coated MEA electrodes, according to the results of the embodiments of the invention;

FIG. 1a is SEM image of CNT-coated MEA electrode (˜20 μm diameter), showing a crater formed by ablating the overlying dielectric layer to access the indium-tin oxide conductor, wherein an inset image under high magnification reveals the porous character of the CNT coating;

FIG. 1b is a graph showing that energy-dispersive X-ray analysis confirms the presence of carbon in the MEA coating;

FIG. 1c is an impedance spectroscopy scan showing the CNT coating led to a decreased impedance at all frequencies (1×10⁻¹ to 1×10⁵ Hz);

FIG. 1d is a cyclic voltammetry scan showing that the CNT coating increases the charge transfer across the electrode surface (0.1 V s⁻¹ scan rate);

FIGS. 1e and f are histograms showing the CNT coating led to a 23-fold decrease in impedance (e) and to a 45-fold increase in charge transfer (f) (±s.e.m., n=20 gold electrodes, n=20 CNT electrodes, 4 MEAs);

FIGS. 2a-b depict the functional effect of CNT-coatings in vitro, according to the results of the embodiments of the invention;

FIG. 2a is a histogram summarizing the neuronal network responses to 400 consecutive 750-mV electrical pulses provided through 20 gold-coated (below horizontal line) and 20 CNT-coated electrodes;

FIG. 2b depicts a stimulus-response curve summarizing seven separate MEA experiments;

FIGS. 3a-f depict characterization of sharpened metal electrodes coated with CNTs, according to the results of the embodiments of the invention;

FIG. 3a shows CNTs covalently attached to a sharp tungsten electrode, according to one embodiment of the invention;

FIG. 3b is a cyclic voltammetry scan showing that covalent coating of CNTs increased the charge transfer;

FIG. 3c is a graph of phase angle versus voltage showing that covalent coating of CNTs decreased the phase angle;

FIG. 3d shows the exposed stainless steel shaft, where the parylene insulation on the electrode is removed by UV laser, according to one embodiment of the invention;

FIG. 3e is a cyclic voltammetry scan showing the CNT-Ppy coatings increased charge transfer by a factor of 1,600;

FIG. 3f are complex-impedance plots showing that enhanced charge transfer results from a drop in the real (Z′) and imaginary (Z″) components of the impedance;

FIGS. 4a-e depict stereotrode recordings from the rat motor cortex, according to the results of the embodiments of the invention;

FIG. 4a shows data recorded from a bare tungsten (red trace) and CNT/gold-coated (black trace) stereotrode tip over 150 ms;

FIG. 4b shows power spectra calculated from 60 s of neural activity. The CNT-coated electrode (black trace) showed increased power when compared with the bare electrode (red trace) at all frequencies (1-1,000 Hz);

FIG. 4c shows an average increase in power for five CNT-coated stereotrodes compared to bare tungsten controls over three different frequency bands (60 Hz notch filter used, 14 separate recordings);

FIGS. 4d and e are spectrograms (1-2,000 Hz) of bare (d) and CNT-coated (e) stereotrodes over 4 seconds, where the recording quality of the CNT electrode exceeds the bare tungsten at all time points and all frequencies;

FIGS. 5a-c depict CNT-coated electrode recordings in the primate visual cortex, according to the results of the embodiments of the invention;

FIG. 5a shows local field potential traces from bare controls (red trace) and CNT-coated (black trace) electrodes show correlated activity but larger amplitude responses from CNT-coated electrodes;

FIG. 5b shows representative power spectral density analysis for the range 1-300 Hz. CNT-coated electrodes acquired an average of 7.4 dB more power (4 coated, 4 control electrodes) and the inset graph shows baseline subtracted view of 60-Hz line-noise peak, where CNT-coated electrodes recorded 17.3 dB less 60-Hz line noise than uncoated controls;

FIG. 5c is a composite of three scanning electron micrographs at a 10 micron scale showing the electrode after recording from the monkey visual cortex and a the inset micrograph shows a view of the electrode tip at a 3 micron scale where the covalently attached CNTs remained intact despite the damage to the parylene insulation; and

FIG. 6 is a flow diagram illustrating methods of using carbon nanotubes to coat neural electrodes, according to three embodiments of the invention.

### DETAILED DESCRIPTION

In the following discussion, three illustrative examples of coating electrodes and test procedures are set forth to provide a thorough understanding of the present invention. These examples are intended to be illustrative rather than limiting in nature. Unless indicated otherwise, all functions described herein may also be automated or performed using either hardware or software, such that the software is embodied on a computer readable medium, or in some combinations thereof such as using processors with code and/or integrated circuits to perform the tasks and procedures.

Wire metal electrodes and neural probes fashioned from silicon, ceramic and flexible substrates may be used to probe or study neural cells such as the brain. The final contact between brain tissue and amplifiers is generally a metal surface. The type of metal, its area of exposure, and the texture of the metal surface determine the properties of the electrodes and therefore the specific application. To enhance electrode sensitivity or increase electric charge for stimulation, the impedance must be lowered. This step generally increases the geometric area of the electrode tip, but with a concomitant loss of selectivity and increased tissue damage during insertion.

The inventions described below, however, establish techniques for coating metal electrodes with carbon nanotubes (CNTs), and test their function in cultured neuronal networks, the motor cortex of anaesthetized rats, and area V4 of rhesus macaques performing a visual task. The results show that CNT-modified electrodes may be robust, may have greatly decreased impedances, may have high charge transfer characteristics, may remain chemically inert and biocompatible, with lower susceptibility to noise, and may have increased ability to activate neurons when used for electrical stimulation. In addition, the inventive procedures may allow the electrodes to retain a small tip size, and thus high selectivity.

A primary significance of these procedures described herein is the rapid, and highly economical, electrolytic modification of any metal surface with a rugged carbon nanotube (CNT) deposition layer. In the area of microelectrodes, they allow modification of existing probes without changes to normal fabrication procedures. Therefore, the advantages of achieving greatly reduced impedance without an increase of the electrode geometry will have a maximum impact on research with microelectrodes, ranging from deep brain stimulation to better signal-to-noise-ratios gathered with conventional electrodes or with microelectrode arrays.

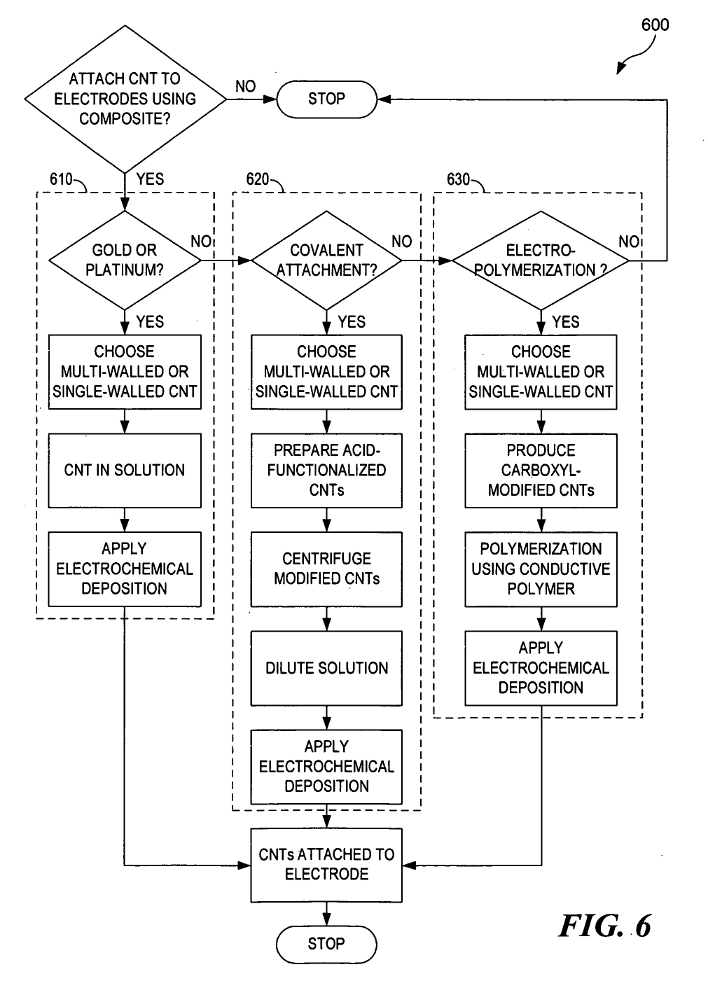

Electrodes may be coated with CNTs using three illustrative methods, such as shown in FIG. 6, element 600. First, generally element group 610, carbon nanotubes may be deposited from an aqueous solution (0.3-3 mg/ml) of multiwalled CNTs (MWNTs) and 10 mM potassium-gold-cyanide (KAuCN) with monophasic voltage pulses (0-1.2 V, 50% duty cycle, 1-12 min). Second, generally element group 620, acid-chloride-functionalized CNTs may be prepared by refluxing COOH-MWNTs with thionyl chloride for 3 h at 80 deg C. The modified CNTs may be centrifuged at 12,000 r.p.m. for 30 min and residual thionyl chloride removed. The COCl-MWNTs may be diluted in dimethylformamide to a concentration of 1 mg/ml. Covalent attachment to amine-modified gold-coated electrode surfaces may be performed by electro-deposition under constant-voltage conditions at 10 V for 70-90 min. Third, generally element group 630, carboxyl-modified CNTs and the conductive polymer (CP) polypyrrole (Ppy) may be polymerized under argon by a constant voltage of 0.75 V from an aqueous solution of 0.5 M Ppy, 1 mg/ml COOH-CNTs. In each of these methods, singlewalled CNTs (SWNTs) may be substituted for MWNTs. Under the last step of electrochemical deposition, the application of energy may be in the form of voltage pulses, voltage ramps, constant voltage, constant current, current ramps, or pulsed-currents Actual deposition voltages may be different from the illustrative example voltages given herein.

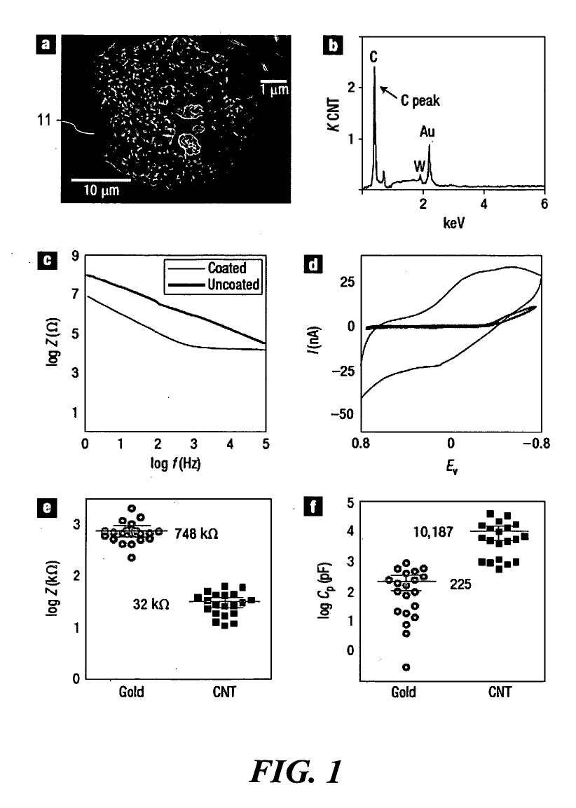

The first illustrative method, in more detail, involved electrochemical deposition of an aqueous suspension of multiwalled CNTs (MWNTs) and potassium-gold cyanide (KAuCN) on indium-tin oxide multi-electrode array (MEA) electrodes (FIG. 1a). FIGS. 1a-1f depict the characterization of CNT-coated MEA electrodes. FIG. 1a is a SEM (scanning electron microscope) image of CNT-coated MEA electrode, element 11, cross-section of about 20 um diameter. The crater shown in FIG. 1a may be formed by ablating the overlying dielectric layer to access the indium-tin oxide conductor, and the inset of FIG. 1a shows a high magnification, revealing the porous character of the CNT coating. The rice-like morphology of the CNT coating may result from the deposition of bundles of nanotubes as opposed to single ones; prolonged sonication at high power levels required to suspend single nanotubes in aqueous solutions were not used. As shown in FIG. 1b, the presence of CNTs were confirmed by analysing the surface composition of the coated electrodes with energy-dispersive X-ray spectrography (EDS) (FIG. 1b).

As shown in FIGS. 1d and c, impedance spectroscopy and cyclic voltammetry were used to determine if the CNT coating altered the electrochemical properties. Impedance spectroscopy measures frequency-dependent changes in impedance, and cyclic voltammetry measures changes in current as an applied voltage pulse is ramped between pre-set limits. Measurements made before and after coating of the electrode in FIG. 1a showed decreased impedance at the biologically relevant frequency of 1 kHz from 940 kV to 38 kV, and an approximately 40-fold increase in charge transfer (FIG. 1c, d respectively) after coating. On average, the CNT/gold composite coating lowered the impedance of MEA electrodes by a factor of 23 at 1 kHz (FIG. 1e), and increased charge transfer by a factor of 45 (FIG. 1f).

Electrical stimulation experiments with cultured neuronal networks grown on 64-electrode MEAs were carried out to test whether the CNT coatings altered the capacity to activate neurons. Thirty-two of the MEA electrodes were coated with gold only, and the other 32 electrodes with the CNT/gold composite. CNT-coated electrodes provided a suitable substrate for neural growth. Dissociated frontal cortex cultures seeded on the CNT-coated electrodes grew vigorously and remained spontaneously active for up to 88 days (oldest time point tested, median age 37 days in vitro n=7 MEAs). A minimum of 60 minutes of spontaneous activity were recorded to permit comparison of the recording characteristics of the different electrode surfaces. The percentage of electrodes with identifiable single units, and the firing rate of the identified units were nearly identical between the two electrode coatings. Other neuronal properties such as waveform shapes and amplitudes were normal when recorded through CNT-coated electrodes. From these observations, it was concluded that electro-deposited CNT coatings are permissive for neuronal growth and function for at least three months, are stable under physiological conditions, and are well suited for recording neural activity.

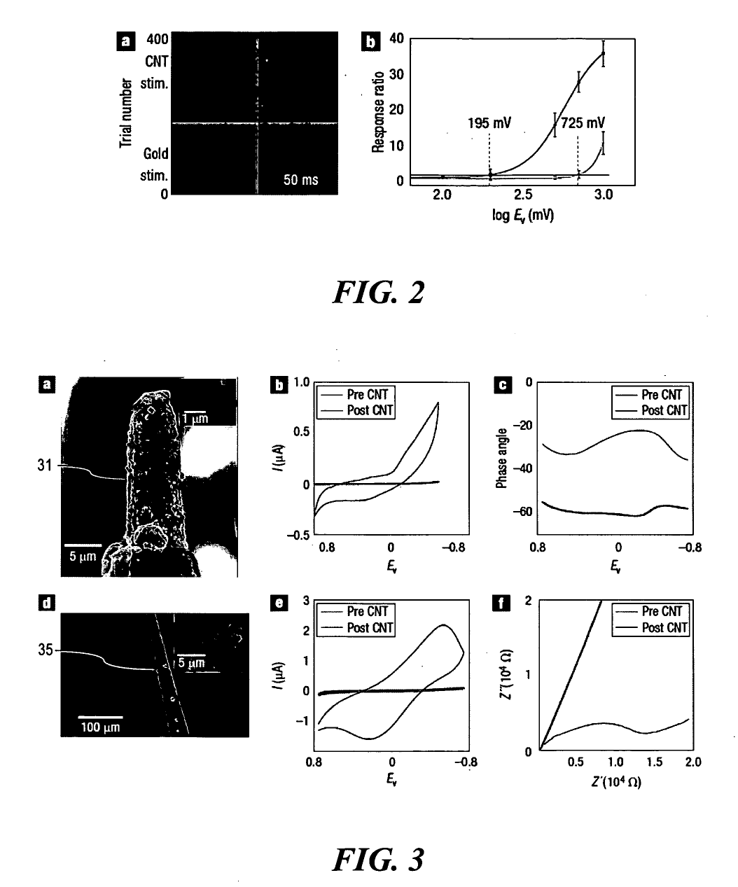

In experiments, stimulus pulses passed through the CNT-coated electrodes were generally more effective in evoking neuronal responses than stimuli introduced through the gold-coated control electrodes. FIGS. 2a-2b show the functional effect of CNT coatings in vitro. FIG. 2a shows a peri-stimulus-time histogram constructed by stacking 400 consecutive 750-mV biphasic stimulus pulses provided through 20 gold-coated and 20 CNT-coated electrodes (10 stimulus pulses/electrode). The color-coded histogram shows the total number of action potentials recorded from the network (1-ms bins) in the 50-ms intervals immediately before and after the stimulus pulses. The stimulus-response curves in FIG. 2b summarize seven separate MEA stimulation experiments as the stimulus intensity was varied from 100-1,000 mV. The threshold for eliciting at least one network response to each electrical stimulus was lowered over 500 mV on CNT-coated electrodes. Voltage-controlled stimulation using CNT-coated electrodes was shown as more effective than gold-coated electrodes at every voltage tested. The increased neural response to may be presumed to be mediated by the lowered impedance and increase in charge transfer through the nanotube coating. Lower electrode impedances may imply lower noise levels; RMS noise levels were found to be on average 65% lower on CNT-coated electrodes compared to gold-coated electrodes. Lower impedances and noise levels may also enhance electrode sensitivity. Some evidence for this may be seen by examining the network responses to electrical stimulation grouped by electrode coating. CNT-coated electrodes recorded neuronal responses to almost twice as many stimulus pulses, even when the stimulus was delivered through a gold electrode. This apparent gain in sensitivity may not have occurred at the expense of selectivity, as the ability to discriminate single neurons was unchanged.

In experiments, the substrate-embedded MEA electrodes proved to be excellent tools for measuring the effects of different electrode coatings on electrical stimulation, even though the planar MEA electrodes are unlike the elongated three-dimensional electrodes used in vivo by most electrophysiologists. Possibly, the flat geometry of the MEA electrodes or the indium-tin oxide metal may be uniquely suited for depositing CNTs. Therefore, the next experiments were chosen to coat commercially available tungsten and stainless steel sharpened wire electrodes by electrochemical deposition of the same CNT/KAuCN solution used to modify the MEA electrodes. As described in Table 1 below, characterization of the successfully modified electrodes showed lowered impedances and increased capacitances comparable to those found using MEA electrodes (Table 1).

TABLE 1
Electrochemical properties of nanotube modified electrodes

| | Normalized impedance | Normalized capacitance |
|---|---|---|
| | (Ω cm⁻²) | (mF cm⁻²) |
| CNT/ED | 0.13 | 2.34 |
| CNT/CoV | 0.075 | 38 |
| CNT/Ppy | 0.77 | 755 |

A second illustrative method of CNT attachment scheme and combination of CNTs was also tested using other materials on the wire electrodes. FIGS. 3a-f show characterization of sharpened metal electrodes which may be coated with CNT's. The covalent attachment of CNTs to an amine-functionalized gold-coated tungsten sharpened wire is shown in FIG. 3a; element 31 is the CNTs covalently attached to a sharp tungsten electrode. COOH-modified MWNTs were functionalized by refluxing with thionyl chloride. The acyl chloride modified nanotubes produced in this reaction were then deposited on an amine-coated gold electrode surface with cathodic current. The increase in charge transfer for the electrode shown in FIG. 3a was greater than 140-fold (FIG. 3b). As shown in FIG. 3c, using AC voltammetry revealed that the covalent coating decreased the phase angle by 30 degrees, implying that the charge transfer mechanism of the CNT-modified surface may be more resistive in character than the original tungsten wire.

A third illustrative method involves electropolymerization of conductive polymers (CPs) such as polypyrrole (Ppy), or polyethylenedioxythiophene (PEDOT), and polythiophene on neural electrodes. In experiments, the combination of CNTs and Ppy was shown to increase charge transfer beyond that seen with CPs alone. Sharp electrodes were coated with mixtures of CNTs and CPs. The electrodes modified with this composite material exhibited increases in charge transfer greater than those found with the CNT/gold or covalent attachment schemes (Table 1). The CNT/Ppy coatings also decreased impedance values and phase angles. FIG. 3d shows a stainless steel electrode (exposed shaft element 35) on which a UV laser was used to remove parylene insulation from randomly chosen locations on the sides of the electrode shaft. A mixture of CNTs was polymerized dispersed in an aqueous pyrrole (0.5 M) solution on the laser-exposed stainless steel. The inset illustration of FIG. 3d shows a crater filled with the CNT/Ppy composite. As shown in FIG. 3e, the increase in charge transfer resulting from this coating was greater than 1,600-fold. As shown in FIG. 3f, a complex plane impedance plot reveals the enhanced charge transfer results from a drop in both real and imaginary components of the impedance.

The third illustrative method in further detail comprised the following: 0.2-5 mg/ml COOH— modified MWCNTs suspended in de-ionized water by ultrasonication for 2 hours were mixed with 0.05-0.5 M polypyrrole solution along with 0.05-0.2 M polystyrenesulfonate under a nitrogen or argon atmosphere. The de-oxygenated CNT/CP solution was placed in a custom coating cell and microwire electrodes loaded into the cell. A flat plate ITO-coated glass 1 cm×1 cm square was used as the counter electrode. The working electrode was connected to the anode of a constant voltage source at 0.8 V for various deposition times. The current during the coating process was monitored, and the total charge passed was recorded—which showed a remarkable increase in charge transfer.

While the illustrative methods have generally used gold, other very-stable metal elements such as platinum may also be used. Similarly, conductive polymers other than Ppy may be substituted, such as polyethylenedioxythiophene (PEDOT). For the nanotubes, single-walled CNT (SWCNT) may be used instead of multi-walled CNT. The substance acting as a counter ion may be different from polystyrenesulfonate or may be omitted entirely in some instances. The nanotube concentrations may be different than 1 mg/ml. The solvents are not limited to aqueous, organic solvents such as dimethylformamide, rather acetonitrile and others may be used either singly or as a mixture with water. Deposition can be done with various electrochemical techniques including but not limited to applying voltage pulses, voltage ramps, constant voltage, constant current, current ramps, or pulsed-currents.

To experimentally verify the inventions described supra, the in vivo recording quality of CNT-coated sharp electrodes was tested in two different preparations: first, in the motor cortex of anaesthetized rats and, second, in the visual cortex area V4 of a monkey. Generally, the motor cortex is the area of the brain of the rat that controls planning and initiation of most voluntary movements. Other researchers target the motor cortex to produce neurally controlled prosthetic devices.

Area V4 of the primate visual cortex is located on the cortical surface, and its physiological responses are well characterized. The efficacy of CNT-coated electrodes for recording and stimulation of surface structures is needed for both basic research and clinical applications, such as neural prosthetics, because large areas of primate sensory and motor representations reside on the cortical surface.

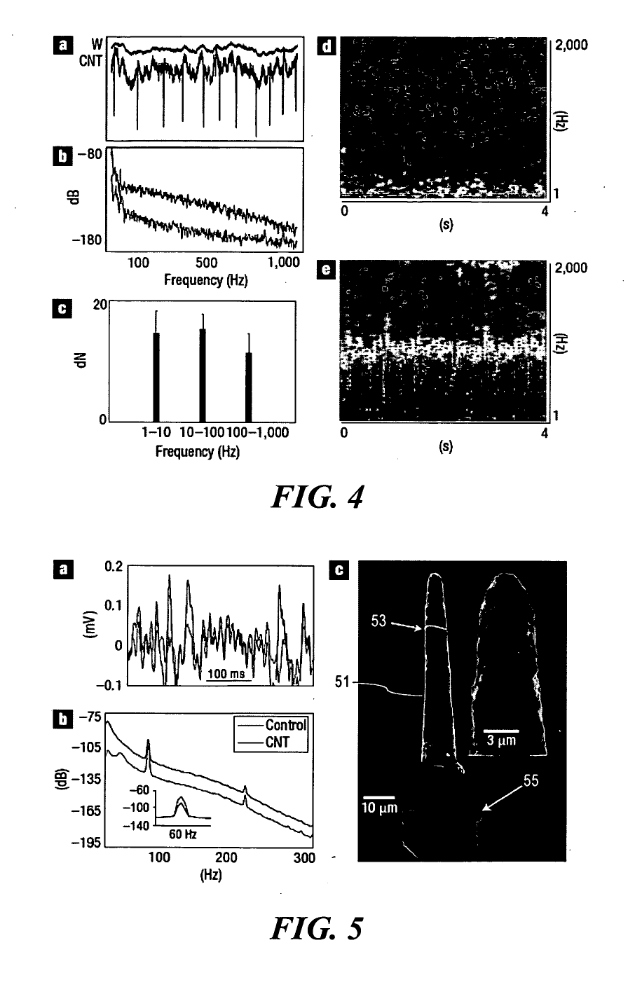

For the rat experiments, tungsten wire stereotrodes were chosen, and the stereotrodes comprised parallel sharpened wire electrodes with separation between the electrode tips of 125 μm. One tip of each stereotrode was coated with CNT/gold, and the other uncoated tip served as control. The unvarying geometric arrangement of the stereotrode tips may have allowed making quantitative comparisons between recording properties of the electrode surfaces, as the small tip separation ensured that both electrodes would monitor virtually the same tissue volume. FIGS. 4a-e show actual stereotrode recordings from the rat motor cortex. FIG. 4a shows traces of raw data recorded from one such stereotrode with an uncoated (top trace 41) and CNT-coated (bottom trace 42) electrode tip. The data were acquired unfiltered (1-8,000 Hz amplifier bandwidth) other than a 60-Hz notch filter to block electric line noise contamination. The measured impedance of the electrode used to acquire the top trace 41 was 924 kV, and the electrode coated with CNT/gold had an impedance of 21 kV (decreased from a measured 1.038 MV before coating). The two traces 41, 42 oscillate in parallel, reflecting the common source of neural activity they recorded. The CNT trace 42 shows large amplitude and relatively fast events representing single neuron spikes. Closer examination reveals that the baseline oscillation amplitude of the CNT trace 42 is also greater, showing the increased sensitivity of the CNT-coated electrode for detecting local field potentials (LFPs), the summed activity of multiple neurons entrained in coherent oscillations.

Though the record from the uncoated electrode shown in FIG. 4a contains usable neural derived data, the differences in the two traces can be appreciated by calculating the power spectra. FIG. 4b shows power spectra produced using 60 sec of data acquired from the same recording session shown in FIG. 4a. The top spectra 43 shows the spectrum of the CNT-coated electrode; the bottom spectra 44 is that of the bare tungsten wire. The CNT electrode data, represented by top spectra 43, has significantly more power at every frequency from 1-1,000 Hz.

FIG. 4c summarizes the differences in power from five different stereotrodes coated in a similar manner; the CNT-coated electrodes averaged 14.7, 15.5 and 9.9 dB increases in the 1-10, 10-100, and 100-1,000 Hz frequency bands, respectively (14 independent recordings, 5 stereotrodes). FIGS. 4d and 4e show spectrograms calculated from 4 sec of stereotrode data spanning 1-2,000 Hz. Obviously, the lower spectrogram reflects the increased information content of the CNT acquired data. CNT/Ppy-modified single-wire electrodes were also used to record in the rat with similar good results.

For the monkey experiments, the covalent attachment scheme described above was used to modify five stainless steel electrodes used for recording in area V4 of monkey cortex. The trained monkey was passively fixated on a spot displayed on a computer screen throughout the recordings. An uncoated control electrode and a CNT electrode were mounted 1 mm apart in a single microdrive; both electrodes were then lowered until they penetrated the dura. All electrodes punctured the dura at a pristine site. Recordings were made after a 30-min rest period to permit tissue settling. FIG. 5a shows 500 ms of simultaneously recorded raw LFP traces for both electrodes, with the traces overlain. The first V4 trace 51 shows the trace for the control electrode and the second V4 trace 52 shows the trace for the CNT coated electrode. The two recordings show a strong temporal correlation; however, similar to what was seen in the stereotrode recordings, the amplitude of the CNT-coated electrode recording is increased compared with the control. Power spectra analysis shows that the CNT electrode data had more power across the frequency band of 1-300 Hz (FIG. 5b). The inset graph of FIG. 5b is a baseline-subtracted overlay highlighting the 60 Hz noise peak; the five CNT electrodes averaged 17.4 dB less line noise contamination, consistent with their lowered impedances.

The durable quality of the CNT coating may be appreciated by examining FIG. 5c. It shows an image of a covalently modified sharp electrode element 51 composed of three separate SEM micrographs taken after the electrode was used for recording from the monkey visual cortex. Before the recording session, the electrode insulation extended to within 20 mm of the tip element 53. The mechanical stress of penetrating the monkey dura may have caused the parylene insulation to peel back from the electrode tip and roll up the shaft element 55. In contrast, the covalently attached CNTs remained intact.

It is shown by the foregoing discussion that CNT-coated electrodes may improve electrochemical and functional properties in cultured neurons, rat motor cortex and monkey visual cortex. The CNT coatings may be applied to a variety of substrates and geometries, as shown by the controlled deposition of CNTs on flat MEA electrodes and sharpened wire electrodes. CNT-coated electrodes may have increased sensitivity for recording neurons, decreased susceptibility to electrical noise, and may function as broadband detectors of neural activity. It may be possible to record LFPs, multiunit activity and neuronal spiking simultaneously with one electrode. The efficacy of electrical stimulation may also be greatly increased by the CNT coatings.

The electro-deposition technique described herein may allow the placement of CNTs and CNT/CP composites on a variety of substrates, similar to the dispersion drying method, but may also permit the flexibility of selective localization and patterning potential using CVD-mediated growth. CVD requires high temperatures (400-900 deg C.), constraining the choice of electrode materials and manufacture. Electro-deposition of CNTs may be carried out under ambient conditions in mild solutions, and may be a flexible process. The electrochemical properties of the coating may be manipulated by controlling CNT concentration, deposition charge, solvent, or co-agents. Regardless of the attachment scheme used, CNT/gold, CNT/Ppy, or covalent linkage through an amide bond, CNTs may improve the recording and stimulating characteristics of neural electrodes. The methods described may have a significant impact on a variety of electrophysiological techniques, including BMI applications requiring bidirectional interaction with the nervous system.

Additional details of the carefully controlled experiments are now described. For the MEA recordings, multielectrode array recording was performed with a Multichannel Acquisition Processor (MAP) System, a computer-controlled 64-channel amplifier system (Plexon). Temperature was controlled at approximately 37 degrees Celsius with a custom designed heating block. Ph was maintained at around 7.35 with a constant flow of humidified having an approximate composition of 90% air/10% CO₂. MEA stimulation experiments were enabled by a custom-designed set of about 64 pre-amplifiers allowing computer control of stimulus channel selection and switching with stimulus artifact rejection circuitry.

For the rat recordings: rats were anaesthetized by IP injection with heads fixed in a stereotaxic frame, and the motor cortex exposed. Sharp electrodes were lowered under micromanipulator control until neural activity was evident on an oscilloscope, then electrodes were further inserted about 800 μm. Electrodes rested undisturbed for 5 min, then spontaneous neural activity was recorded with a 16-channel Recorder System (Plexon). A total of nine rats were used in these experiments, with 5-14 separate recordings acquired from each rat.

For the monkey recordings, recordings were made from cortical area V4 while the monkey was passively fixating a spot on a video monitor. A flashing color square was used to verify that cortical responses were normal. A CNT-modified electrode and a control electrode separated by 1 mm were simultaneously introduced through pristine dura using a single microdrive. After electrode insertion, a period of at least 30 min was allowed for tissue settling before data collection. One monkey was used in these experiments during two different recording sessions.

Further, the scanning electron micrographs were acquired on an FEI Quanta 200 ESEM under low vacuum conditions. Surface composition analysis was carried out with a Genesis XM2 X-ray microanalysis tool (EDAX). Electrochemical evaluation of electrodes was performed with a CHI 6007C potentiostat (CH Instruments). And finally, student paired and unpaired t-test was used to evaluate the statistical significance of coating effects on electrode performance, P<0.05.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered desirable by those skilled in the art based upon a review of the foregoing description of preferred embodiments. Accordingly, it is appropriate that the appended claims be construed broadly and in a manner consistent with the scope of the invention.

What is claimed is:

1. A method of attaching carbon nanotubes to electrodes comprising a step of:
depositing a composite of carbon nanotubes (CNTs) on neural electrodes, wherein the composite with CNTs is selected from the group consisting of gold, platinum, polypyrrole, polyethylenedioxythiophene, conductive polymers, covalent linkage through an amide bond.

2. A method of coating electrodes comprising a step of:
depositing a composite of carbon nanotubes (CNTs) and gold or platinum on neural electrodes.

3. The method of claim 2, wherein the CNTs are multiwalled or singlewalled.

4. The method of claim 2, wherein the gold is potassium-gold-cyanide, or gold-chloride.

5. The method of claim 2 further comprising steps of:
forming an aqueous solution of multiwalled CNTs and gold; and
using the aqueous solution for the depositing.

6. The method of claim 2 further comprising a step of:
using electrochemical techniques for the step of depositing including applying monophasic voltage pulses or other voltage pulses, or voltage ramps, or a constant voltage, or a constant current, or current ramps, or pulsed-current conditions.

7. The method of claim 5 further comprising a step of:
using electrochemical techniques for the step of depositing including applying monophasic voltage pulses, or other voltage pulses, or voltage ramps, or a constant voltage, or a constant current, or current ramps, or pulsed-current conditions.

8. The method of claim 2 further comprising steps of:
forming an aqueous solution of CNTs and gold or platinum, wherein the CNTs are multiwalled and the gold is potassium-gold-cyanide or gold-chloride;
using the aqueous solution for the depositing; and
applying electrochemical techniques for the depositing.

9. The method of claim 2 further comprising steps of:
forming an aqueous solution up to 3 mg/ml of CNTs and gold, wherein the CNTs are multiwalled and the gold is 10 mM potassium-gold-cyanide;
using the aqueous solution for the depositing; and
applying electrochemical techniques for the depositing.

10. The method of claim 2 further comprising a step of:
using bundles or individually dispersed CNTs for the depositing.

11. A coated electrode comprising:
a metal electrode; and
a coating of a composite deposited on the metal electrode, wherein the coating comprises carbon nanotubes (CNTs) and gold or platinum.

12. The coated electrode of claim 11, wherein the CNTs are multiwalled and the gold is potassium-gold-cyanide.

13. The coated electrode of claim 11, wherein the coating is porous and the CNTs are bundles of CNTs.

14. A method for coating electrodes comprising a step of:
depositing a composite of carbon nanotubes (CNTs) and conductive polymers on neural electrodes.

15. The method of claim 14, wherein the conductive polymer is polypyrrole or polyethylenedioxythiophene.

16. The method of claim 14, wherein the step of depositing comprises electropolymerization.

17. The method of claim 14, wherein the step of depositing comprises electropolymerization;
and a mixture of CNTs are polymerized dispersed in an aqueous pyrrole solution.

18. The method of claim 17, wherein the step of electropolymerization is done and under argon by deposition with electrochemical techniques including applying voltage pulses, voltage ramps, constant voltage, constant current, current ramps, or pulsed-current conditions.

19. The method of claim 14 further comprising a step of:
altering the CNTs to provide carboxyl-modified CNTS.

20. The method of claim 19 further comprising a step of:
polymerizing the carboxyl-modified CNTS and conductive polymer for the depositing.

21. The method of claim 20, the conductive polymer is polypyrrole or polyethylenedioxythiophene.

22. The method of claim 14, wherein the conductive polymer is polypyrrole, and the method further comprising the steps of:
altering the CNTs to provide carboxyl-modified CNTS; and
polymerizing the carboxyl-modified CNTS and polypyrrole under argon by a constant voltage for the depositing.

23. The method of claim 22, wherein the step of polymerizing is:
polymerizing the carboxyl-modified CNTS and polypyrrole (Ppy) under argon by a constant voltage from an aqueous solution of Ppy and COOH-CNTs, or an equivalent ratio of the aqueous or organic solution.

24. A coated electrode comprising:
a metal electrode; and
a coating of a composite deposited on the metal electrode, wherein the coating comprises carbon nanotubes (CNTs) and conductive polymers.

25. The coated electrode of claim 24, wherein the CNTs are carboxyl-modified CNTs and the conductive polymer is polypyrrole

26. The coated electrode of claim 24, wherein the CNTs are carboxyl-modified CNTs and the conductive polymer is polyethylenedioxythiophene.

27. The coated electrode of claim 24, wherein the CNTs are carboxyl-modified CNTs (COOH-CNTs), the conductive polymer is polypyrrole, and the electrode is laser-exposed metal.

28. The coated electrode of claim 24, wherein the CNTs are carboxyl-modified CNTs (COOH-CNTs), the conductive polymer is polypyrrole (Ppy), the electrode is metal; and the coating comprises an aqueous or organic solution of Ppy and COOH-CNTs.

29. A method for coating electrodes comprising a step of:
electrodepositing modified carbon nanotubes (CNTs) on neural electrodes, wherein the modified CNTs are acid-chloride-functionalized CNTs.

30. The method of claim 28, wherein the amine-modified CNTs are multiwalled or single-walled SWCNTs

31. The method of claim 28, wherein the modified CNTs are multiwalled (MWNTs); and the acid-chloride-functionalized CNTs are prepared by refluxing COOH-MWNTs with thionyl chloride.

32. The method of claim 30 further comprising steps of:
centrifuging the modified CNTs; and
removing the residual thionyl chloride.

33. The method of claim 31 further comprising steps of:
removing the residual thionyl chloride to form a remaining COCI-MWNTs; and
diluting the COCI-MWNTs in dimethylformamide.

34. The method of claim 32 further comprising a step of:
performing the electrodepositing under constant-voltage.

35. The method of claim 28, wherein the neural electrodes have gold-coated surfaces; and the electrodepositing comprises covalent attachment of the acid-chloride-functionalized CNTs to the gold-coated surfaces.
